(19) United States
(12) Patent Application Publication
(10) Pub. No.: US 2023/0399819 A1
(43) Pub. Date: Dec. 14, 2023

(54) EXCAVATION POINT IDENTIFICATION DEVICE

(71) Applicant: NEC Corporation, Minato-ku, Tokyo (JP)

(72) Inventors: Yosuke Kakuno, Tokyo (JP); Tatsuya Yoshimoto, Tokyo (JP)

(73) Assignee: NEC Corporation, Minato-ku, Tokyo (JP)

(21) Appl. No.: 18/033,732

(22) PCT Filed: Oct. 11, 2021
(86) PCT No.: PCT/JP2021/037508

§ 371 Date: Apr. 25, 2023

(30) Foreign Application Priority Data
Nov. 9, 2020 (JP) 2020-1868 16

(51) Int. Cl. E02F 9/26; E02F 3/43

(52) U.S. Cl. CPC E02F 9/262; E02F 3/437

(57) ABSTRACT

Provided is an excavation point identification apparatus which can efficiently carry out excavation even if a shape of an excavation target has changed. An extraction section (12) extracts, with reference to pieces of height information at a plurality of points of an excavation target to be excavated by an excavation apparatus, a plurality of excavation point candidates each of which is a candidate for an excavation point at which the excavation apparatus starts excavation. An inference section (13) infers, based on an excavation track of the excavation apparatus, an excavation amount, in which the excavation apparatus carries out excavation, for each of the plurality of excavation point candidates which have been extracted by the extraction section (12). A selection section (14) selects an excavation point from among the plurality of excavation point candidates based on the excavation amount which has been inferred by the inference section (13).

### TECHNICAL FIELD

The present invention relates to an excavation point identification apparatus that identifies an excavation point at which an excavation apparatus starts excavation.

### BACKGROUND ART

Utilization of robots is attracting attention as a measure for dealing with a decrease in the number of workers due to an aging population with a low birth rate and for dealing with an increase in workload due to a shortage of labor. Especially in the construction industry, it is an urgent task to raise productivity through labor saving in order to deal with urgent problems of shortage of labor and inheritance of skills due to aging of field workers and a decrease in young workers. In this respect, in recent years, there has been great expectation for automation of construction using construction machines. As technologies related to this, there are inventions disclosed in Patent Literatures 1 and 2 below.

Patent Literature 1 relates to a shovel including a lower traveling body, an upper rotary body which is rotatably mounted on the lower traveling body, an excavation attachment which is attached to the upper rotary body, and a control apparatus. The control apparatus has a setting section for setting a target track, which is a track followed by a predetermined portion of a bucket, based on information on a landform before excavation starts and a target excavation volume.

Patent Literature 2 relates to a method for planning earthwork using an excavation machine having a work tool. In the method, an excavation area is divided into a plurality of excavation sites using expert heuristics. For each excavation area, at least one candidate position is determined at which the bucket starts excavation. Then, an excavation result at each excavation candidate position is predicted. Then, at least one performance parameter is evaluated to determine a quality level of the predicted excavation result, and a start position is selected as a function of the quality level of the predicted excavation result.

### CITATION LIST

### Patent Literature

[Patent Literature 1]

International Publication No. WO 2019/189260

[Patent Literature 2]

Japanese Patent Application Publication Tokukaihei No. 11-247230

### SUMMARY OF INVENTION

### Technical Problem

In the shovel disclosed in Patent Literature 1, a target track, which is a track followed by the predetermined portion of the bucket, is set based on information on a landform before excavation is started and a target excavation volume. However, there have been a problem that, if a range in which a sensor can measure is continuously excavated in a case where an excavation target has been excavated to have a shape which is not suitable for excavation, or in a case where an excavation target has collapsed during excavation, efficient excavation may not be carried out.

In the method for planning earthwork disclosed in Patent Literature 2, an excavation result at each excavation candidate position is predicted, and at least one performance parameter is evaluated so as to determine the quality level of the predicted excavation result. Then, a start position is selected as a function of the quality level of the predicted excavation result. However, there has been a problem that, at a site where earth and sand is sequentially carried in and a shape of the earth and sand changes, efficient excavation may not be carried out by excavation under a predetermined scenario.

An example aspect of the present invention is accomplished in view of the above problems, and its example object is to provide a technique in which excavation can be efficiently carried out even in a case where a shape of an excavation target has changed.

### Solution to Problem

An excavation point identification apparatus according to an example aspect of the present invention includes: an acquisition means of acquiring pieces of height information at a plurality of points in an excavation target which is to be excavated by an excavation apparatus; an extraction means of extracting a plurality of excavation point candidates with reference to the pieces of height information, each of the plurality of excavation point candidates being a candidate for an excavation point at which the excavation apparatus starts excavation; an inference means of inferring, based on an excavation track of the excavation apparatus, an excavation amount for each of the plurality of excavation point candidates which have been extracted by the extraction means, the excavation amount being an amount by which the excavation apparatus carries out excavation; and a selection means of selecting an excavation point from among the plurality of excavation point candidates based on the excavation amount which has been inferred by the inference means.

An excavation point identification system according to an example aspect of the present invention includes: a measurement means of measuring an area including an excavation target which is to be excavated by an excavation apparatus; an acquisition means of acquiring, with reference to measurement information which has been received from the measurement means, pieces of height information at a plurality of points in the excavation target which is to be excavated by the excavation apparatus; an extraction means of extracting a plurality of excavation point candidates with reference to the pieces of height information, each of the plurality of excavation point candidates being a candidate for an excavation point at which the excavation apparatus starts excavation; an inference means of inferring, based on an excavation track of the excavation apparatus, an excavation amount for each of the plurality of excavation point candidates which have been extracted by the extraction means, the excavation amount being an amount by which the excavation apparatus carries out excavation; and a selection means of selecting an excavation point from among the plurality of excavation point candidates based on the excavation amount which has been inferred by the inference means.

An excavation point identification method according to an example aspect of the present invention includes: acquiring pieces of height information at a plurality of points in an excavation target which is to be excavated by an excavation apparatus; extracting a plurality of excavation point candidates with reference to the pieces of height information, each of the plurality of excavation point candidates being a candidate for an excavation point at which the excavation apparatus starts excavation; inferring, based on an excavation track of the excavation apparatus, an excavation amount for each of the plurality of excavation point candidates which have been extracted, the excavation amount being an amount by which the excavation apparatus carries out excavation; and selecting an excavation point from among the plurality of excavation point candidates based on the excavation amount which has been inferred.

### Advantageous Effects of Invention

According to an example aspect of the present invention, it is possible to efficiently carry out excavation even in a case where a shape of an excavation target has changed.

### BRIEF DESCRIPTION OF DRAWINGS

FIG. 1 is a block diagram illustrating a configuration of an excavation point identification apparatus according to a first example embodiment of the present invention.

FIG. 2 is a flowchart illustrating a flow of an excavation point identification method according to the first example embodiment of the present invention.

FIG. 3 is a block diagram illustrating a configuration of an excavation point identification system according to a second example embodiment of the present invention.

FIG. 4 is a flowchart illustrating a flow of an excavation point identification method according to the second example embodiment of the present invention.

FIG. 5 is a block diagram illustrating a functional configuration of an excavation point identification apparatus according to a third example embodiment of the present invention.

FIG. 6 is a diagram for describing an installation position of a measurement apparatus (sensor).

FIG. 7 is a diagram illustrating an excavation area which has been divided into a plurality of meshes by an area division section.

FIG. 8 is a diagram illustrating an example of a mesh which is excluded from excavation point candidates.

FIG. 9 is a diagram for describing a method of inferring an excavation amount by an inference section.

FIG. 10 is a flowchart for describing process procedures of the excavation point identification apparatus according to the third example embodiment of the present invention.

FIG. 11 is a block diagram illustrating a functional configuration of an excavation point identification system according to a fourth example embodiment of the present invention.

FIG. 12 is a flowchart illustrating a flow of an excavation point identification method according to the fourth example embodiment of the present invention.

FIG. 13 is a diagram illustrating a configuration example of a computer.

### EXAMPLE EMBODIMENTS

### First Example Embodiment

The following description will discuss a first example embodiment of the present invention in detail with reference to the drawings. The present example embodiment is a basic form of example embodiments described later.

Control of excavation work by an excavation apparatus can be both control which is based on a predetermined scenario and control which is not based on such a scenario.

As an excavation point identification method which is not based on a predetermined scenario, it is conceivable that an excavation target which has been accumulated is measured by a measurement apparatus, and an excavation position is determined only from a measurement result. However, in a case where the excavation position is simply determined based only on a height of the excavation target, a point at which excavation cannot be efficiently carried out may be selected as an excavation point depending on a shape.

For example, if a point which is a highest point of an excavation target is determined as an excavation point, efficient excavation cannot be carried out because, at a point where the excavation target has accumulated in a wall shape, a loading amount into the bucket is small even when the bucket is pulled. Moreover, if all excavation possible ranges are assumed to be candidates for excavation start points, an amount of information necessary for determining an excavation point increases. Therefore, an amount of calculation becomes enormous, and such an operation is unsuitable in the field of automatic operation where quick response is demanded.

The excavation point identification apparatus according to the present example embodiment identifies an excavation point such that efficient excavation can be carried out regardless of a shape of an excavation target, and reduces an amount of information necessary to identify an excavation point.

(Configuration of Excavation Point Identification Apparatus)

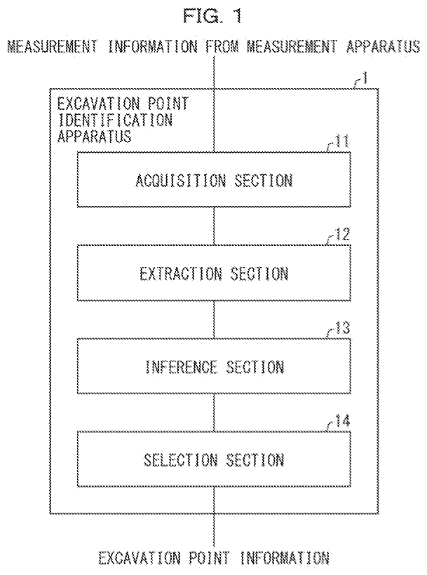

The following description will discuss a configuration of an excavation point identification apparatus 1 according to the present example embodiment with reference to FIG. 1. FIG. 1 is block diagram illustrating the configuration of the excavation point identification apparatus 1. The excavation point identification apparatus 1 includes an acquisition section 11, an extraction section 12, an inference section 13, and a selection section 14.

Note that the sections of the excavation point identification apparatus 1 can be provided in separate apparatuses. For example, the acquisition section 11 and the extraction section 12 can constitute a single apparatus, and an inference section 13 and a selection section 14 can constitute a single apparatus. These can be mounted on a single apparatus, or can be mounted on separate apparatuses. For example, in a case of being mounted on separate apparatuses, pieces of information of the respective sections are transmitted and received via a communication network to proceed with a process. Alternatively, in a case where the sections of the excavation point identification apparatus 1 operate on a cloud, pieces of information of the respective sections are transmitted and received via a communication network to proceed with a process.

The acquisition section 11 acquires pieces of height information at a plurality of points of an excavation target which is to be excavated by the excavation apparatus. For example, a measurement apparatus such as a 3D sensor disposed at an upper portion of the excavation apparatus measures heights at a plurality of points in an area including the excavation target. The acquisition section 11 then acquires pieces of height information which have been measured by the measurement apparatus. Examples of the 3D sensor include cameras such as a depth camera, a stereo camera, and a time-of-flight (ToF) camera, laser sensors such as a 2D light detection and ranging (LiDAR) and a 3D LiDAR, radar sensors, and the like.

The extraction section 12 extracts, with reference to the pieces of height information acquired by the acquisition section 11, a plurality of excavation point candidates each of which is a candidate for an excavation point at which the excavation apparatus starts excavation. For example, the extraction section 12 extracts, as excavation point candidates, a plurality of points for each of which height information acquired by the acquisition section 11 is not less than a predetermined value.

The inference section 13 infers, based on an excavation track of the excavation apparatus, an excavation amount, in which the excavation apparatus carries out excavation, for each of the plurality of excavation point candidates which have been extracted by the extraction section 12. For example, the inference section 13 infers an excavation amount based on an excavation target on a track (excavation track) of a bucket followed when the excavation apparatus carries out excavation.

The selection section 14 selects an excavation point from among the plurality of excavation point candidates based on the excavation amount which has been inferred by the inference section 13. For example, the selection section 14 selects, as an excavation point, an excavation point candidate for which an excavation amount is largest.

As described above, in the excavation point identification apparatus 1 according to the present example embodiment, the configuration is employed in which: a plurality of excavation point candidates each of which is a candidate for an excavation point at which the excavation apparatus starts excavation are extracted with reference to the height information; and then an excavation point is selected from among the plurality of excavation point candidates based on the excavation amount which has been inferred based on the excavation track of the excavation apparatus. Therefore, according to the excavation point identification apparatus 1 of the present example embodiment, it is possible to bring about an effect of efficiently identifying an excavation point even in a case where a shape of an excavation target has changed.

(Flow of Excavation Point Identification Method)

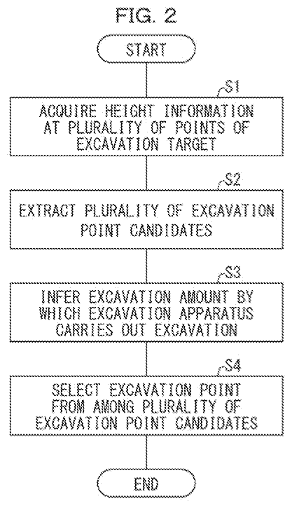

The following description will discuss a flow of an excavation point identification method according to the present example embodiment, with reference to FIG. 2. FIG. 2 is a flowchart illustrating the flow of the excavation point identification method. First, the excavation point identification apparatus 1 acquires pieces of height information at a plurality of points of an excavation target which is to be excavated by the excavation apparatus (S1).

Next, the excavation point identification apparatus 1 extracts, with reference to the pieces of height information, a plurality of excavation point candidates each of which is a candidate for an excavation point at which the excavation apparatus starts excavation (S2).

Next, the excavation point identification apparatus 1 infers, based on an excavation track of the excavation apparatus, an excavation amount, in which the excavation apparatus carries out excavation, for each of the plurality of excavation point candidates which have been extracted (S3).

Lastly, the excavation point identification apparatus 1 selects an excavation point from among the plurality of excavation point candidates based on the inferred excavation amount (S4).

As described above, in the excavation point identification method according to the present example embodiment, the configuration is employed in which: a plurality of excavation point candidates each of which is a candidate for an excavation point at which the excavation apparatus starts excavation are extracted; and then an excavation point is selected from among the plurality of excavation point candidates based on the excavation amount which has been inferred based on the excavation track of the excavation apparatus. Therefore, according to the excavation point identification method of the present example embodiment, it is possible to bring about an effect of efficiently identifying an excavation point with a large excavation amount even in a case where a shape of an excavation target has changed. Therefore, it is possible to bring about an effect of efficiently carrying out excavation even in a case where a shape of an excavation target has changed.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are not repeated.

(Configuration Example of Excavation Point Identification System)

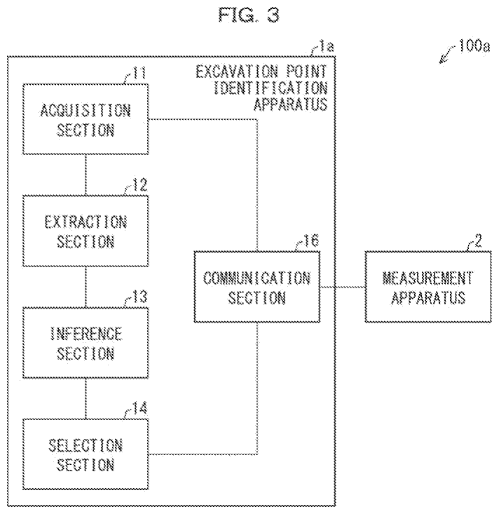

FIG. 3 is a block diagram illustrating a configuration of an excavation point identification system 100a. The excavation point identification system 100a includes an excavation point identification apparatus 1a and a measurement apparatus 2. The excavation point identification apparatus 1a includes an acquisition section 11, an extraction section 12, an inference section 13, a selection section 14, and a communication section 16.

Note that the sections of the excavation point identification apparatus la can be provided in separate apparatuses. For example, the acquisition section 11 and the extraction section 12 can constitute a single apparatus, and an inference section 13 and a selection section 14 can constitute a single apparatus. These can be mounted on a single apparatus, or can be mounted on separate apparatuses. For example, in a case of being mounted on separate apparatuses, pieces of information of the respective sections are transmitted and received via a communication network to proceed with a process. Alternatively, in a case where the sections of the excavation point identification apparatus la operate on a cloud, pieces of information of the respective sections are transmitted and received via a communication network to proceed with a process.

The measurement apparatus 2 measures an area including an excavation target which is to be excavated by the excavation apparatus 3. The communication section 16 receives measurement information of an area measured by the measurement apparatus 2 and transmits an excavation point at which the excavation apparatus 3 starts excavation.

For example, in a case where a plurality of measurement apparatuses 2 are provided in a work site and it is possible to measure a plurality of excavation areas, the communication section 16 can be configured to receive measurement information from a measurement apparatus 2 which is closest to the excavation apparatus 3. Thus, even in a case where the excavation apparatus 3 moves, it is possible to acquire measurement information from an optimal measurement apparatus 2.

Alternatively, a plurality of measurement apparatuses 2 are arranged in a work site to prepare measurement information which is obtained by superimposing measurement results of the plurality of measurement apparatuses 2. Then, it is possible to select an excavation point based on the measurement information. With the configuration, it is possible to set a wider range as an excavation target, and to acquire measurement information with high accuracy even in a case where the excavation apparatus 3 moves.

The acquisition section 11 acquires, with reference to measurement information received by the communication section 16, pieces of height information at a plurality of points of an excavation target which is to be excavated by the excavation apparatus 3. For example, the measurement apparatus 2 such as a 3D sensor disposed at an upper portion of the excavation apparatus 3 measures heights at a plurality of points in an area including the excavation target. The acquisition section 11 then acquires pieces of height information which have been measured by the measurement apparatus 2.

The extraction section 12 extracts, with reference to the pieces of height information acquired by the acquisition section 11, a plurality of excavation point candidates each of which is a candidate for an excavation point at which the excavation apparatus starts excavation. For example, the extraction section 12 extracts, as excavation point candidates, a plurality of points for each of which height information acquired by the acquisition section 11 is not less than a predetermined value.

The inference section 13 infers, based on an excavation track of the excavation apparatus, an excavation amount, in which the excavation apparatus carries out excavation, for each of the plurality of excavation point candidates which have been extracted by the extraction section 12. For example, the inference section 13 infers an excavation amount based on an excavation target on a track (excavation track) of a bucket followed when the excavation apparatus carries out excavation.

The selection section 14 selects an excavation point from among the plurality of excavation point candidates based on the excavation amount which has been inferred by the inference section 13, and causes the communication section 16 to transmit the excavation point. For example, the selection section 14 selects, as an excavation point, an excavation point candidate for which an excavation amount is largest.

(Process Procedures of Excavation Point Identification System)

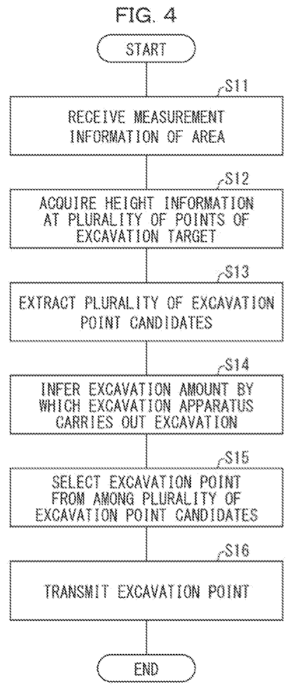

The following description will discuss a flow of an excavation point identification method according to the present example embodiment, with reference to FIG. 4. FIG. 4 is a flowchart illustrating the flow of the excavation point identification method. First, the communication section 16 receives measurement information of an area from the measurement apparatus 2 (S11).

Next, the acquisition section 11 acquires pieces of height information at a plurality of points of the excavation target which is to be excavated by the excavation apparatus 3 (S12). Then, the extraction section 12 extracts, with reference to the pieces of height information, a plurality of excavation point candidates each of which is a candidate for an excavation point at which the excavation apparatus 3 starts excavation (S13).

Next, the inference section 13 infers, based on an excavation track of the excavation apparatus 3, an excavation amount, in which the excavation apparatus 3 carries out excavation, for each of the plurality of excavation point candidates which have been extracted (S14). Then, the selection section 14 selects an excavation point from among the plurality of excavation point candidates based on the inferred excavation amount (S15), and causes the communication section 16 to transmit the excavation point (S16).

As described above, in the excavation point identification system 100a according to the present example embodiment, the configuration is employed in which: the acquisition section 11 acquires, with reference to measurement information which has been received by the communication section 16, pieces of height information at a plurality of points of an excavation target which is to be excavated by the excavation apparatus 3; then, with reference to the pieces of height information, the extraction section 12 extracts a plurality of excavation point candidates each of which is a candidate for an excavation point at which the excavation apparatus starts excavation; and then the selection section 14 selects an excavation point from among the plurality of excavation point candidates based on the excavation amount which has been inferred based on the excavation track of the excavation apparatus. Therefore, according to the excavation point identification apparatus la of the present example embodiment, it is possible to bring about an effect of efficiently identifying an excavation point even in a case where a shape of an excavation target has changed.

### Third Example Embodiment

The following description will discuss a third example embodiment of the present invention in detail with reference to the drawings. The same reference numerals are given to constituent elements which have functions identical with those described in the first example embodiment, and descriptions as to such constituent elements are omitted as appropriate.

(Configuration of Excavation Point Identification Apparatus)

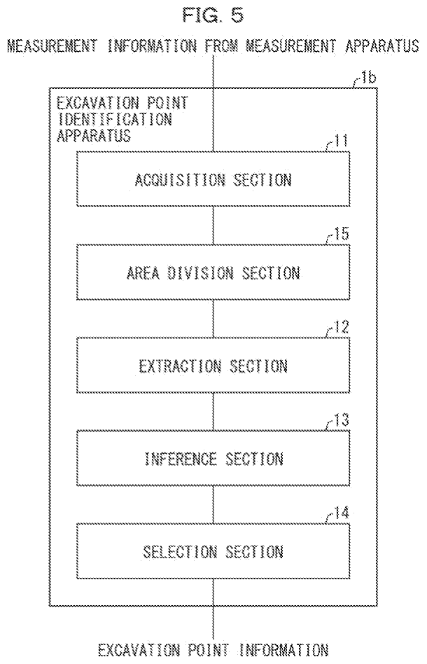

FIG. 5 is block diagram illustrating a functional configuration of an excavation point identification apparatus 1b according to the third example embodiment. The excavation point identification apparatus 1b includes an acquisition section 11, an extraction section 12, an inference section 13, a selection section 14, and an area division section 15.

The acquisition section 11 acquires pieces of height information which have been measured by a measurement apparatus. The measurement apparatus is constituted by a 3D sensor or the like disposed at an upper portion of an excavation apparatus, and measures heights at a plurality of points in an area including an excavation target.

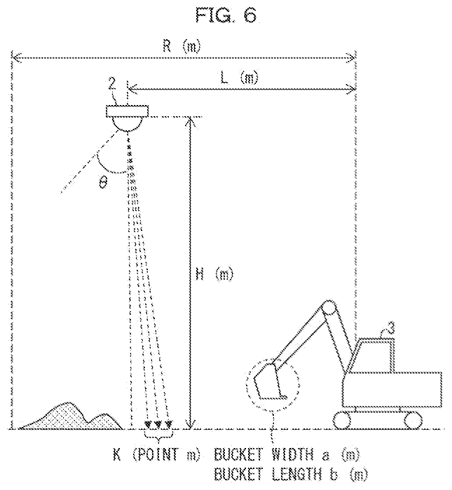

FIG. 6 is a diagram for describing an installation position of a measurement apparatus (sensor). The measurement apparatus 2 measures an excavation target (earth and sand) which is to be excavated by the excavation apparatus 3. The measurement information in which the measurement apparatus 2 has measured the excavation target includes at least two-dimensional coordinate information horizontal to the ground and height information from the ground to the excavation target.

The measurement apparatus 2 has, for example, a conical field of view defined by a viewing angle θ from a central axis, and is capable of measuring two-dimensional coordinate information and height information of an excavation target included in the range. For the measurement apparatus 2, the number of specific points K (unit: number of points×meter) per unit area (1 m²) with respect to a measurement distance is determined and, as a height H (unit: meter) from the ground to the measurement apparatus 2 decreases, the measurement range becomes narrower. Therefore, it is possible to carry out more detailed measurement. In the present example embodiment, as in the following expression (expression 1), an installation height H of the measurement apparatus 2 is determined such that the number of measurement points in an area of 1 m² is not less than a predetermined number N1. Here, the predetermined number N1 can be set as appropriate while taking into consideration accuracy and the like demanded at a work site. For example, N1 can be 200, but this does not limit the present example embodiment.

K/H≥N1 (Expression 1)

An installation position L of the measurement apparatus 2 is determined by an expression (expression 2) below such that an entire excavation range falls within a sensor view. Note that the installation position L (unit: meter) of the measurement apparatus 2 is assumed to be a distance from a point directly below the measurement apparatus 2 to the excavation apparatus 3. Moreover, an excavation distance R (unit: meter) is assumed to be a distance from the excavation apparatus 3 to an excavation start point.

H×tan θ>(R−L) (Expression 2)

The measurement apparatus 2 can be disposed outside the excavation target when viewed from the excavation apparatus 3. In this case, a range outside the excavation target is also included in the measurement range. Therefore, assuming that a closest distance from the excavation apparatus 3 to the excavation target is R1 and a farthest distance is R2, expression 2 is as follows.

When L <R1, 1.

H×tan θ>(R2−L) (Expression 2-1)

When R1≥L≥R2, 2.

H×tan θ>(R2−L) and H×tan θ>(L−R1) (Expression 2-2)

When L>R2, 3.

H−tan θ>(L−R1) (Expression 2-3)

The measurement apparatus 2 is installed at an upper portion of the excavation apparatus 3 as illustrated in FIG. 6, and can measure an excavation target. In an environment in which excavation targets (earth and sand) are sequentially added by a truck or the like, the measurement apparatus 2 can be fixed.

The measurement apparatus 2 can be configured to be attached to a crane or the like and move in in accordance with movement of the excavation apparatus 3. Alternatively, the measurement apparatus 2 can be attached to an upper portion of the excavation apparatus 3 and move together with the excavation apparatus 3. The measurement apparatus 2 can be installed on a ceiling or a column at which an area can be viewed from above.

As described above, measurement accuracy decreases as the height of the measurement apparatus 2 increases. Therefore, it is necessary to arrange the measurement apparatus 2 such that the height is not greater than a predetermined height. Therefore, any installation method can be employed as long as the measurement apparatus 2 is installed such that the height is not greater than the predetermined height.

The area division section 15 divides the area which includes the excavation target and which has been measured by the measurement apparatus 2 into a plurality of meshes.

For example, the area division section 15 divides the area into a plurality of meshes in which a shape of each mesh is a square of S×S (where S is a length of one side and a unit is meters). Here, the length S of one side of the mesh is set such that, for example, expression 3 and expression 4 below are satisfied.

In expression 3, “a” and “b” represent a width and a length of the bucket of the excavation apparatus 3, respectively. Moreover, “min” represents a function that returns a minimum value of an argument. Expression 3 indicates that the length S of one side of the mesh is set to be smaller than the width and the length of the bucket and is set to be greater than a lower limit ML. Here, a value of the lower limit ML can be set as appropriate while taking into consideration a processing capability of the excavation point identification apparatus 1a or the like. For example, ML can be 0.1 m, but this does not limit the present example embodiment.

Expression 4 indicates that the length S of one side of the mesh is set such that a single mesh includes N2 or more measurement points. Here, a value of N2 can be set as appropriate while taking into consideration demanded accuracy, a processing capability of the excavation point identification apparatus 1a, and the like. For example, N2 can be 2, but this does not limit the present example embodiment.

min(a,b)>S>ML (Expression 3)

S²⁻K/H≥N2 (Expression 4):

In the present example embodiment, the shape of the mesh is described as a square. Note, however, that the present example embodiment is not limited thereto. For example, the shape of the mesh can be a rectangular shape, or can be any other shape.

FIG. 7 is a diagram illustrating an excavation area which has been divided into a plurality of meshes by the area division section 15. In FIG. 7, the excavation area is divided into a total of 36 meshes in a matrix of 6×6. In the example illustrated in FIG. 7, meshes are prepared such that two (predetermined number) or more measurement points (indicated by black dots in FIG. 7) by the measurement apparatus 2 are included in a single mesh, as shown in a mesh M1.

The extraction section 12 calculates a height of an excavation target in a mesh based on pieces of height information of a plurality of measurement points included in the mesh obtained by dividing the excavation area. For example, an average value of the pieces of height information of the plurality of measurement points can be used as the height of the excavation target in the mesh, or a median value of the pieces of height information of the plurality of measurement points can be used as the height of the excavation target in the mesh.

In FIG. 7, a thicker tone is given as the height of the excavation target (earth and sand) in meshes increases. For example, meshes M2 and M3 each indicate that the height of the excavation target (earth and sand) is highest.

The extraction section 12 extracts, as an excavation point candidate, a mesh for which height information of the excavation target is not less than a predetermined value Th. For example, the extraction section 12 extracts, as excavation point candidates, the meshes M2 and M3 for which height information is highest. Here, a specific method for setting the predetermined value does not limit the present example embodiment, but an example configuration as below can be employed for setting the predetermined value. The following setting examples can be used in combination.
Setting example 1: A maximum value of a height which is reachable by the shovel of the excavation apparatus 3 is multiplied by a predetermined coefficient a1 which is smaller than 1, and a value thus obtained is set as the predetermined value Th.
Setting example 2: A greatest height among the excavation target included in the plurality of meshes obtained by division by the area division section 15 is multiplied by a predetermined coefficient a2 which is smaller than 1, and a value thus obtained is set as the predetermined value Th.

Setting example 1 is a configuration in which the predetermined value Th is set based on information pertaining to a physical configuration of the excavation apparatus 3 itself. For example, in a case where the maximum value of the height reachable by the shovel is 5.0 m and the predetermined coefficient a1 is 0.6, the predetermined value Th is 3.0 m. Here, the predetermined coefficient a1 can be determined in accordance with an operating characteristic of the shovel of the excavation apparatus 3, and the like.

Setting example 2 is a configuration in which the predetermined value Th is adaptively set in accordance with a status of the excavation target. For example, in a case where the greatest height of the excavation target included in the plurality of meshes is 4.0 m and the predetermined coefficient a2 is 0.7, the predetermined value Th is 2.8 m. Here, the predetermined coefficient a2 can be determined in accordance with a status of an excavation site, a property of an excavation target, and the like.

The extraction section 12 extracts an excavation point candidate such that the excavation point candidate does not overlap a direction in which the excavation apparatus 3 pulls the shovel.

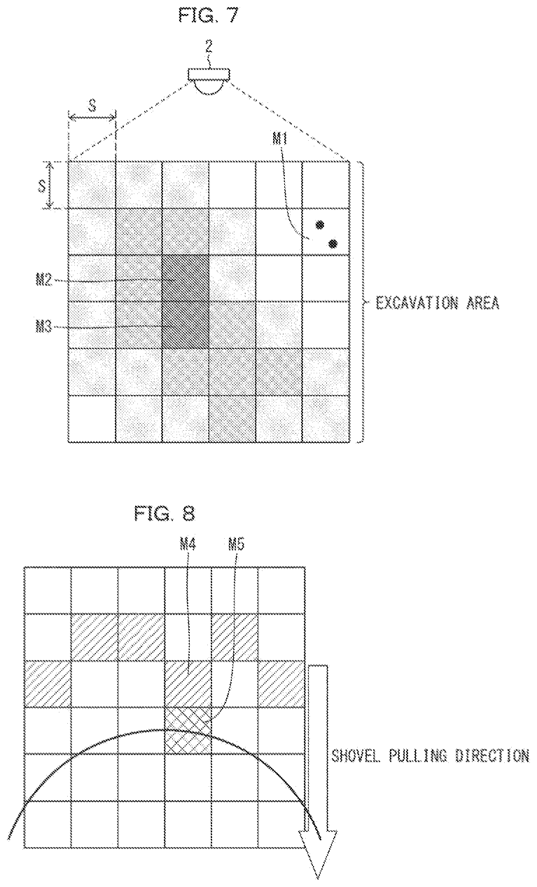

FIG. 8 is a diagram illustrating an example of a mesh which is excluded from excavation point candidates. In FIG. 8, meshes with oblique lines each indicate a mesh in which a height of the excavation target is large. For example, in a case where the extraction section 12 extracts a mesh M4 as an excavation point candidate, the excavation apparatus 3 carries out excavation from the mesh M4. Therefore, a mesh M5 is included in a direction (excavation track) in which the shovel is pulled. In this case, the extraction section 12 excludes the mesh M5 from the excavation point candidate. That is, in a case where an excavation region that is indicated by an excavation track, where any excavation point candidate (first excavation point candidate) among the plurality of excavation point candidates is assumed to be an excavation point, includes another excavation point candidate (second excavation point candidate), the another excavation point candidate (second excavation point candidate) is excluded from the plurality of excavation point candidates.

The extraction section 12 can prevent a range which is unreachable by the shovel of the excavation apparatus 3 from being set as an excavation point candidate. By thus excluding a mesh included in a direction in which the excavation apparatus 3 pulls the shovel and a mesh which is unreachable by the shovel from excavation point candidates, it is possible to reduce a target for which an excavation amount is calculated.

The inference section 13 infers an excavation amount with reference to height information in a mesh included in the excavation track of the excavation apparatus 3. It is possible to employ a configuration in which an excavation track is calculated in an apparatus different from the excavation point identification apparatus 1b and the inference section 13 acquires the calculated excavation track via the communication section 16. Alternatively, it is possible to employ a configuration in which an excavation track is calculated in the inference section 13.

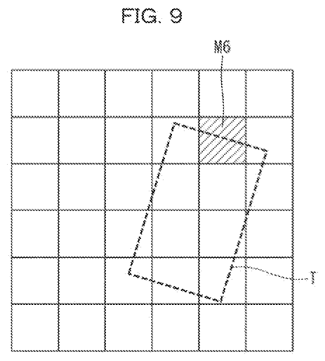

FIG. 9 is a diagram for describing a method of inferring an excavation amount by the inference section 13. In FIG. 9, a rectangle T indicates an excavation track of the shovel followed when the excavation apparatus 3 pulls the shovel from a mesh M6. The inference section 13 infers an excavation amount based on pieces of height information in meshes included in the excavation track T. For example, the inference section 13 directly adds height information of a mesh which is completely included in the excavation track T. Further, for a mesh partially included in the excavation track T, an area ratio of the mesh included in the excavation track T is obtained, and a value obtained by multiplying height information by the area ratio is added. Thus, the inference section 13 infers an excavation amount by the shovel, by adding the pieces of height information in accordance with area ratios of meshes included in the excavation track T.

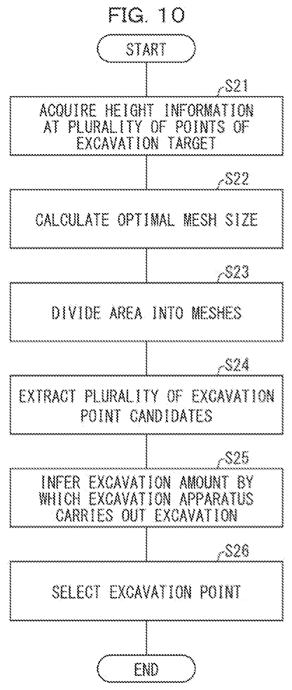

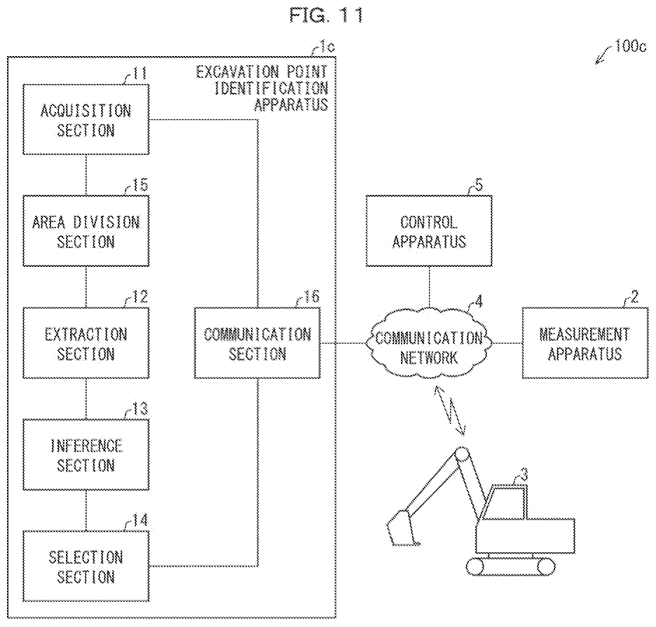

FIG. 10 is a flowchart for describing process procedures of the excavation point identification apparatus 1b according to the third example embodiment. First, the acquisition section 11 acquires pieces of height information at a plurality of points of an excavation target which is to be excavated by the excavation apparatus 3 (S21).

Next, the area division section 15 calculates a size of a mesh for dividing an area (S22), and divides the area which includes the excavation target and which has been measured by the measurement apparatus 2 into a plurality of meshes (S23).

Next, the extraction section 12 extracts, with reference to pieces of height information included in the meshes obtained by division by the area division section 15, a plurality of excavation point candidates each of which is a candidate for an excavation point at which the excavation apparatus 3 starts excavation (S24).

Next, the inference section 13 infers, based on an excavation track of the excavation apparatus 3, an excavation amount, in which the excavation apparatus 3 carries out excavation, for each of the plurality of excavation point candidates which have been extracted by the extraction section 12 (S25).

Lastly, the selection section 14 selects an excavation point from among the plurality of excavation point candidates based on the excavation amount which has been inferred by the inference section 13 (S26).

In the above description, a case has been described in which an excavation point for a single excavation apparatus is identified. However, the present example embodiment can also be applied to a case where excavation points are identified for a plurality of excavation apparatuses. For example, in the excavation area illustrated in FIG. 9, excavation tracks are provided so that the excavation tracks of a plurality of excavation apparatuses do not overlap each other, and a plurality of excavation points corresponding to the plurality of excavation apparatuses are selected from excavation point candidates.

(Effect of Excavation Point Identification Apparatus 1a)

As described above, in the excavation point identification apparatus 1b according to the present example embodiment, the configuration is employed in which the extraction section 12 extracts, as an excavation point candidate, a mesh for which height information of an excavation target is not less than a predetermined value. Therefore, according to the excavation point identification apparatus 1b of the present example embodiment, it is possible to bring about an effect of easily extracting excavation point candidates, in addition to the effects brought about by the excavation point identification apparatus 1 according to the first example embodiment.

Further, in the excavation point identification apparatus 1b according to the present example embodiment, the configuration is employed in which the area division section 15 calculates a size of a mesh such that the number of measurement points of the measurement apparatus included in the mesh is not less than a predetermined number. Therefore, according to the excavation point identification apparatus 1b of the present example embodiment, it is possible to bring about an effect of easily applying a filter for inhibiting a sensor measurement error and setting a mesh to have an appropriate size, in addition to the effects brought about by the excavation point identification apparatus 1 according to the first example embodiment.

Further, in the excavation point identification apparatus 1b according to the present example embodiment, the configuration is employed in which the inference section 13 infers an excavation amount with reference to height information in a mesh included in the excavation track of the excavation apparatus. Therefore, according to the excavation point identification apparatus 1b of the present example embodiment, it is possible to bring about an effect of easily calculating an excavation amount where an excavation point candidate is an excavation start point, in addition to the effects brought about by the excavation point identification apparatus 1 according to the first example embodiment.

Further, in the excavation point identification apparatus 1b according to the present example embodiment, the configuration is employed in which, in a case where an excavation region that is indicated by an excavation track, where any excavation point candidate (first excavation point candidate) among the plurality of excavation point candidates is assumed to be an excavation point, includes another excavation point candidate (second excavation point candidate), the extraction section 12 excludes the another excavation point candidate (second excavation point candidate) from the plurality of excavation point candidates. Therefore, according to the excavation point identification apparatus 1b of the present example embodiment, it is possible to bring about effects of appropriately reducing the number of excavation point candidates and reducing a computation amount in calculation of an excavation amount, in addition to the effects brought about by the excavation point identification apparatus 1 according to the first example embodiment.

Further, in the excavation point identification apparatus 1b according to the present example embodiment, the configuration is employed in which the extraction section 12 does not set an excavation point candidate in a range which is unreachable by the shovel of the excavation apparatus. Therefore, according to the excavation point identification apparatus 1b of the present example embodiment, it is possible to bring about effects of appropriately reducing the number of excavation point candidates and reducing a computation amount in calculation of an excavation amount, in addition to the effects brought about by the excavation point identification apparatus 1 according to the first example embodiment.

### Fourth Example Embodiment

The following description will discuss a fourth example embodiment of the present invention in detail with reference to the drawings. The same reference numerals are given to constituent elements which have functions identical with those described in the third example embodiment, and descriptions as to such constituent elements are omitted as appropriate.

(Configuration of Excavation Point Identification System)

FIG. 11 is a block diagram illustrating a functional configuration of an excavation point identification system 100c according to the fourth example embodiment. The excavation point identification system 100c includes an excavation point identification apparatus 1c, a measurement apparatus 2, an excavation apparatus 3, a communication network 4, and a control apparatus 5.

The measurement apparatus 2 and the control apparatus 5 are connected to the communication network 4 such as a local area network (LAN) in a wired or wireless manner, and are capable of communicating with the excavation point identification apparatus 1c. The excavation apparatus 3 is wirelessly connected to the communication network 4 such as a LAN. The control apparatus 5 controls excavation work of the excavation apparatus 3 via the communication network 4.

The excavation point identification apparatus 1c includes an acquisition section 11, an extraction section 12, an inference section 13, a selection section 14, an area division section 15, and a communication section 16.

The communication section 16 is connected to the communication network 4 such as a LAN, receives measurement information of an area measured by the measurement apparatus 2, and transmits an excavation point at which the excavation apparatus 3 starts excavation to the control apparatus 5.

The control apparatus 5 receives the excavation point at which the excavation apparatus 3 starts excavation from the excavation point identification apparatus 1c via the communication network 4, and controls the excavation apparatus 3 via the communication network 4 such that the excavation apparatus 3 starts excavation from the excavation point.

The acquisition section 11 acquires, with reference to measurement information received by the communication section 16, pieces of height information at a plurality of points of an excavation target which is to be excavated by the excavation apparatus 3.

The area division section 15 divides the area including the excavation target which has been received by the communication section 16 into a plurality of meshes. Moreover, the area division section 15 calculates a size of a mesh such that the number of measurement points of the measurement apparatus 2 included in the mesh is not less than a predetermined number.

The extraction section 12 calculates a height of an excavation target in a mesh based on pieces of height information of a plurality of measurement points included in the mesh obtained by dividing the excavation area. Then, the extraction section 12 extracts, as an excavation point candidate, a mesh for which height information of the excavation target is not less than a predetermined value.

In a case where an excavation region that is indicated by an excavation track, where any excavation point candidate (first excavation point candidate) among the plurality of excavation point candidates is assumed to be an excavation point, includes another excavation point candidate (second excavation point candidate), the extraction section 12 excludes the another excavation point candidate (second excavation point candidate) from the plurality of excavation point candidates.

The extraction section 12 does not set an excavation point candidate in a range which is unreachable by the shovel of the excavation apparatus 3.

The inference section 13 infers an excavation amount with reference to height information in a mesh included in the excavation track of the excavation apparatus 3.

The selection section 14 selects an excavation point from among the plurality of excavation point candidates based on the excavation amount which has been inferred by the inference section 13. The selection section 14 causes the communication section 16 to transmit the excavation point to the control apparatus 5.

(Process Procedures of Excavation Point Identification System)

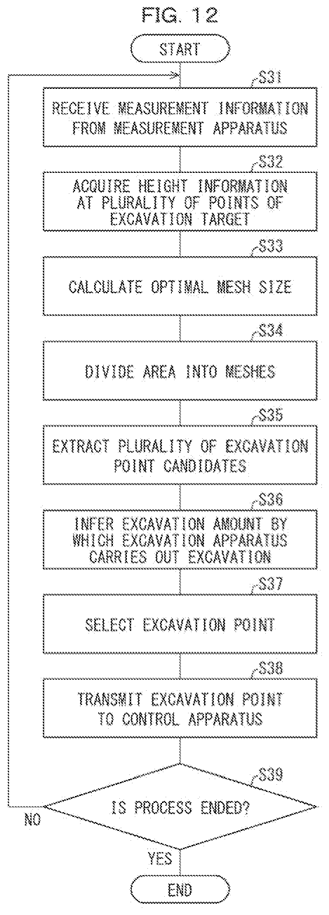

The following description will discuss a flow of an excavation point identification method according to the present example embodiment, with reference to FIG. 12. FIG. 12 is a flowchart illustrating the flow of the excavation point identification method. First, the communication section 16 receives measurement information of an area from the measurement apparatus 2 (S31).

Next, the acquisition section 11 acquires pieces of height information at a plurality of points of the excavation target which is to be excavated by the excavation apparatus 3 (S32).

Next, the area division section 15 calculates an optimal size of a mesh for dividing an area (S33), and divides the area which includes the excavation target and which has been measured by the measurement apparatus 2 into a plurality of meshes (S34).

Next, the extraction section 12 extracts, with reference to pieces of height information included in the meshes obtained by division by the area division section 15, a plurality of excavation point candidates each of which is a candidate for an excavation point at which the excavation apparatus 3 starts excavation (S35).

Next, the inference section 13 infers, based on an excavation track of the excavation apparatus 3, an excavation amount, in which the excavation apparatus 3 carries out excavation, for each of the plurality of excavation point candidates which have been extracted (S36). Then, the selection section 14 selects an excavation point from among the plurality of excavation point candidates based on the inferred excavation amount (S37), and causes the communication section 16 to transmit the excavation point (S38).

Lastly, it is determined whether or not to end the process (S39). For example, in a case of ending excavation of the excavation target by the excavation apparatus 3 (Yes in S39), the process ends. In a case where excavation of the excavation target by the excavation apparatus 3 is continued (No in S39), the process returns to step S31 and the subsequent processes are repeated. Note that the process of calculating the mesh size (S33) may be carried out only once when an excavation point is selected for the first time, and the process of S33 may be omitted for and subsequent to the second time.

(Effect of Excavation Point Identification System 100c)

As described above, in the excavation point identification system 100c according to the present example embodiment, the configuration is employed in which the extraction section 12 extracts, as an excavation point candidate, a mesh for which height information of an excavation target is not less than a predetermined value. Therefore, according to the excavation point identification system 100c of the present example embodiment, it is possible to bring about an effect of easily extracting excavation point candidates, in addition to the effects brought about by the excavation point identification system 100a according to the second example embodiment.

Moreover, the configuration is employed in which the control apparatus 5 receives an excavation point from the excavation point identification apparatus 1c via the communication network 4 and controls excavation work of the excavation apparatus 3. Therefore, the control apparatus may control the excavation apparatus 3 to carry out excavation at the excavation point, and this brings about an effect of easily carrying out control of the excavation apparatus 3.

Further, in the excavation point identification system 100c according to the present example embodiment, the configuration is employed in which the area division section 15 calculates a size of a mesh such that the number of measurement points of the measurement apparatus included in the mesh is not less than a predetermined number. Therefore, according to the excavation point identification system 100c of the present example embodiment, it is possible to bring about an effect of easily applying a filter for inhibiting a sensor measurement error and setting a mesh to have an appropriate size, in addition to the effects brought about by the excavation point identification system 100a according to the second example embodiment.

Further, in the excavation point identification system 100c according to the present example embodiment, the configuration is employed in which the inference section 13 infers an excavation amount with reference to height information in a mesh included in the excavation track of the excavation apparatus. Therefore, according to the excavation point identification system 100c of the present example embodiment, it is possible to bring about an effect of easily calculating an excavation amount where an excavation point candidate is an excavation start point, in addition to the effects brought about by the excavation point identification system 100a according to the second example embodiment.

Further, in the excavation point identification system 100c according to the present example embodiment, the configuration is employed in which, in a case where an excavation region that is indicated by an excavation track, where any excavation point candidate (first excavation point candidate) among the plurality of excavation point candidates is assumed to be an excavation point, includes another excavation point candidate (second excavation point candidate), the extraction section 12 excludes the another excavation point candidate (second excavation point candidate) from the plurality of excavation point candidates. Therefore, according to the excavation point identification system 100c of the present example embodiment, it is possible to bring about effects of appropriately reducing the number of excavation point candidates and reducing a computation amount in calculation of an excavation amount, in addition to the effects brought about by the excavation point identification system 100a according to the second example embodiment.

Further, in the excavation point identification system 100c according to the present example embodiment, the configuration is employed in which the extraction section 12 does not set an excavation point candidate in a range which is unreachable by the shovel of the excavation apparatus. Therefore, according to the excavation point identification system 100c of the present example embodiment, it is possible to bring about effects of appropriately reducing the number of excavation point candidates and reducing a computation amount in calculation of an excavation amount, in addition to the effects brought about by the excavation point identification system 100a according to the second example embodiment.

### Software Implementation Example

The functions of part of or all of the excavation point identification apparatuses 1, 1a, 1b, and 1c can be realized by hardware such as an integrated circuit (IC chip) or can be alternatively realized by software.

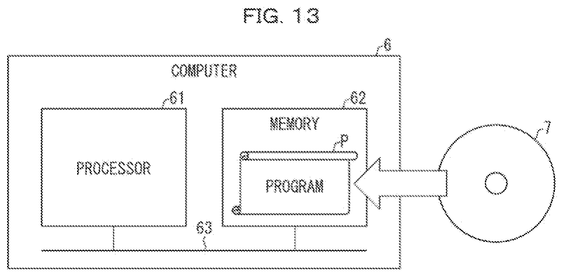

In the latter case, each of the excavation point identification apparatuses 1, 1a, 1b, and 1c is realized by, for example, a computer that executes instructions of a program that is software realizing the foregoing functions. FIG. 13 illustrates an example of such a computer (hereinafter, referred to as “computer 6”). The computer 6 includes at least one processor 61 and at least one memory 62 which are connected to each other via an internal bus 63. The memory 62 stores a program P for causing the computer 6 to function as the excavation point identification apparatuses 1, 1a, 1b, and 1c. In the computer 6, the processor 61 reads the program P from the memory 62 and executes the program P, so that the functions of the excavation point identification apparatuses 1, 1a, 1b, and 1c are realized.

As the processor 61, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, general-purpose computing on graphics processing units (GPGPU), or a combination of these. The memory 62 can be, for example, a flash memory, a hard disk drive (HDD), a solid state drive (SSD), or a combination of these.

Note that the computer 6 can further include a random access memory (RAM) in which the program P is loaded when the program P is executed and in which various kinds of data are temporarily stored. The computer 6 can further include a communication interface for carrying out transmission and reception of data with other apparatuses. The computer 6 can further include an input-output interface for connecting input-output apparatuses such as a keyboard, a mouse, a display and a printer.

The program P can be stored in a non-transitory tangible storage medium 7 which is readable by the computer 6. The storage medium 7 can be, for example, a compact disc-read only memory (CD-ROM), a digital versatile disc (DVD), a tape, a disk, a card, a semiconductor memory, a programmable logic circuit, or the like. The computer 6 can obtain the program P via the storage medium 7. The program P can be transmitted via a transmission medium. The transmission medium can be, for example, a communications network, a broadcast wave, or the like. The computer 6 can obtain the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

Some of or all of the foregoing example embodiments can also be described as below. Note, however, that the present invention is not limited to the following supplementary notes.

(Supplementary Note 1)

An excavation point identification apparatus, including: an acquisition means of acquiring pieces of height information at a plurality of points in an excavation target which is to be excavated by an excavation apparatus; an extraction means of extracting a plurality of excavation point candidates with reference to the pieces of height information, each of the plurality of excavation point candidates being a candidate for an excavation point at which the excavation apparatus starts excavation; an inference means of inferring, based on an excavation track of the excavation apparatus, an excavation amount for each of the plurality of excavation point candidates which have been extracted by the extraction means, the excavation amount being an amount by which the excavation apparatus carries out excavation; and a selection means of selecting an excavation point from among the plurality of excavation point candidates based on the excavation amount which has been inferred by the inference means.

According to the configuration, it is possible to efficiently identify an excavation point at which an excavation amount is large, even in a case where a shape of an excavation target has changed.

(Supplementary Note 2)

The excavation point identification apparatus according to supplementary note 1, further including: an area division means of dividing an area including the excavation target into a plurality of meshes, in which the extraction means extracts, as the excavation point candidate, a mesh from among the plurality of meshes in accordance with height information of the excavation target.

According to the configuration, it is possible to easily extract an excavation point candidate.

(Supplementary Note 3)

The excavation point identification apparatus according to supplementary note 2, in which: the area division means calculates a size of each of the plurality of meshes such that the number of measurement points of a measurement apparatus included in the mesh is not less than a predetermined number.

According to the configuration, it is easy to apply a filter for inhibiting a sensor measurement error, and it is possible to set a mesh to have an appropriate size.

(Supplementary Note 4)

The excavation point identification apparatus according to supplementary note 2 or 3, in which: the inference means infers the excavation amount with reference to pieces of height information in meshes included in the excavation track of the excavation apparatus.

According to the configuration, it is possible to easily calculate an excavation amount where an excavation point candidate is an excavation start point.

(Supplementary Note 5)

The excavation point identification apparatus according to any one of supplementary notes 1 through 4, in which: in a case where an excavation region that is indicated by an excavation track, where a first excavation point candidate included in the plurality of excavation point candidates is assumed to be an excavation point, includes a second excavation point candidate included in the plurality of excavation point candidates, the extraction means excludes the second excavation point candidate from the plurality of excavation point candidates.

According to the configuration, it is possible to appropriately reduce the number of excavation point candidates, and to reduce a computation amount in calculation of an excavation amount.

(Supplementary Note 6)

The excavation point identification apparatus according to any of supplementary notes 1 through 5, in which: the extraction means does not set the excavation point candidate in a range which is unreachable by a shovel of the excavation apparatus.

According to the configuration, it is possible to appropriately reduce the number of excavation point candidates, and to reduce a computation amount in calculation of an excavation amount.

(Supplementary Note 7)

An excavation point identification system, comprising: a measurement means of measuring an area including an excavation target which is to be excavated by an excavation apparatus; an acquisition means of acquiring, with reference to measurement information which has been received from the measurement means, pieces of height information at a plurality of points in the excavation target which is to be excavated by the excavation apparatus; an extraction means of extracting a plurality of excavation point candidates with reference to the pieces of height information, each of the plurality of excavation point candidates being a candidate for an excavation point at which the excavation apparatus starts excavation; an inference means of inferring, based on an excavation track of the excavation apparatus, an excavation amount for each of the plurality of excavation point candidates which have been extracted by the extraction means, the excavation amount being an amount by which the excavation apparatus carries out excavation; and a selection means of selecting an excavation point from among the plurality of excavation point candidates based on the excavation amount which has been inferred by the inference means.

According to the configuration, it is possible to efficiently identify an excavation point at which an excavation amount is large, even in a case where a shape of an excavation target has changed.

(Supplementary Note 8)

The excavation point identification system according to supplementary note 7, further including: an area division means of dividing an area including the excavation target into a plurality of meshes, in which the extraction means extracts, as the excavation point candidate, a mesh from among the plurality of meshes in accordance with height information of the excavation target.

According to the configuration, it is possible to easily extract an excavation point candidate.

(Supplementary Note 9)

The excavation point identification system according to supplementary note 8, in which: the area division means calculates a size of each of the plurality of meshes such that the number of measurement points of the measurement means included in the mesh is not less than a predetermined number.

According to the configuration, it is easy to apply a filter for inhibiting a sensor measurement error, and it is possible to set a mesh to have an appropriate size.

(Supplementary Note 10)

The excavation point identification system according to supplementary note 8 or 9, in which: the inference means infers the excavation amount with reference to pieces of height information in meshes included in the excavation track of the excavation apparatus.

According to the configuration, it is possible to easily calculate an excavation amount where an excavation point candidate is an excavation start point.

(Supplementary Note 11)

The excavation point identification system according to any of supplementary notes 7 through 10, in which: in a case where an excavation region that is indicated by an excavation track, where a first excavation point candidate included in the plurality of excavation point candidates is assumed to be an excavation point, includes a second excavation point candidate included in the plurality of excavation point candidates, the extraction means excludes the second excavation point candidate from the plurality of excavation point candidates.

According to the configuration, it is possible to appropriately reduce the number of excavation point candidates, and to reduce a computation amount in calculation of an excavation amount.

(Supplementary Note 12)

The excavation point identification system according to any of supplementary notes 7 through 11, in which: the extraction means does not set the excavation point candidate in a range which is unreachable by a shovel of the excavation apparatus.

According to the configuration, it is possible to appropriately reduce the number of excavation point candidates, and to reduce a computation amount in calculation of an excavation amount.

(Supplementary Note 13)

An excavation point identification method, including: acquiring pieces of height information at a plurality of points in an excavation target which is to be excavated by an excavation apparatus; extracting a plurality of excavation point candidates with reference to the pieces of height information, each of the plurality of excavation point candidates being a candidate for an excavation point at which the excavation apparatus starts excavation; inferring, based on an excavation track of the excavation apparatus, an excavation amount for each of the plurality of excavation point candidates which have been extracted, the excavation amount being an amount by which the excavation apparatus carries out excavation; and selecting an excavation point from among the plurality of excavation point candidates based on the excavation amount which has been inferred.

According to the configuration, it is possible to efficiently identify an excavation point at which an excavation amount is large, even in a case where a shape of an excavation target has changed.

(Supplementary Note 14)

The excavation point identification method according to supplementary note 13, further including: dividing an area including the excavation target into a plurality of meshes, in the extracting of the plurality of excavation point candidates, a mesh from among the plurality of meshes is extracted as the excavation point candidate in accordance with height information of the excavation target.

According to the configuration, it is possible to easily extract an excavation point candidate.

(Supplementary Note 15)

The excavation point identification method according to supplementary note 14, in which: in the dividing into the plurality of meshes, a size of each of the plurality of meshes is calculated such that the number of measurement points of a measurement apparatus included in the mesh is not less than a predetermined number.

According to the configuration, it is easy to apply a filter for inhibiting a sensor measurement error, and it is possible to set a mesh to have an appropriate size.

(Supplementary Note 16)

The excavation point identification method according to supplementary note 14 or 15, in which: in the inferring of an excavation amount by which the excavation apparatus carries out excavation, the excavation amount is inferred with reference to pieces of height information in meshes included in the excavation track of the excavation apparatus. According to the configuration, it is possible to easily calculate an excavation amount where an excavation point candidate is an excavation start point.

(Supplementary Note 17)

The excavation point identification method according to any of supplementary notes 13 through 16, in which: in a case where an excavation region that is indicated by an excavation track, where a first excavation point candidate included in the plurality of excavation point candidates is assumed to be an excavation point, includes a second excavation point candidate included in the plurality of excavation point candidates, the second excavation point candidate is excluded from the plurality of excavation point candidates in the extracting of the plurality of excavation point candidates.

According to the configuration, it is possible to appropriately reduce the number of excavation point candidates, and to reduce a computation amount in calculation of an excavation amount.

(Supplementary Note 18)

The excavation point identification method according to any of supplementary notes 13 through 17, in which: in the extracting of the plurality of excavation point candidates, the excavation point candidate is not set in a range which is unreachable by a shovel of the excavation apparatus.

According to the configuration, it is possible to appropriately reduce the number of excavation point candidates, and to reduce a computation amount in calculation of an excavation amount.

(Supplementary Note 19)

A program for causing a computer to function as an excavation point identification apparatus, the program causing the computer to function as: an acquisition means of acquiring pieces of height information at a plurality of points in an excavation target which is to be excavated by an excavation apparatus; an extraction means of extracting a plurality of excavation point candidates with reference to the pieces of height information, each of the plurality of excavation point candidates being a candidate for an excavation point at which the excavation apparatus starts excavation; an inference means of inferring, based on an excavation track of the excavation apparatus, an excavation amount for each of the plurality of excavation point candidates which have been extracted by the extraction means, the excavation amount being an amount by which the excavation apparatus carries out excavation; and a selection means of selecting an excavation point from among the plurality of excavation point candidates based on the excavation amount which has been inferred by the inference means.

(Supplementary Note 20)

A computer-readable storage medium storing a program for causing a computer to function as an excavation point identification apparatus, the program causing the computer to function as: an acquisition means of acquiring pieces of height information at a plurality of points in an excavation target which is to be excavated by an excavation apparatus; an extraction means of extracting a plurality of excavation point candidates with reference to the pieces of height information, each of the plurality of excavation point candidates being a candidate for an excavation point at which the excavation apparatus starts excavation; an inference means of inferring, based on an excavation track of the excavation apparatus, an excavation amount for each of the plurality of excavation point candidates which have been extracted by the extraction means, the excavation amount being an amount by which the excavation apparatus carries out excavation; and a selection means of selecting an excavation point from among the plurality of excavation point candidates based on the excavation amount which has been inferred by the inference means.

(Supplementary Note 21)

An excavation point identification apparatus including at least one processor, the at least one processor carrying out: a process of acquiring pieces of height information at a plurality of points in an excavation target which is to be excavated by an excavation apparatus; a process of extracting a plurality of excavation point candidates with reference to the pieces of height information, each of the plurality of excavation point candidates being a candidate for an excavation point at which the excavation apparatus starts excavation; a process of inferring, based on an excavation track of the excavation apparatus, an excavation amount for each of the plurality of excavation point candidates which have been extracted, the excavation amount being an amount by which the excavation apparatus carries out excavation; and a process of selecting an excavation point from among the plurality of excavation point candidates based on the excavation amount which has been inferred.

Note that the excavation point identification apparatus can further include a memory. The memory can store a program for causing the processor to execute the acquisition process, the extraction process, the inference process, and the selection process. The program can be stored in a computer-readable non-transitory tangible storage medium.

### REFERENCE SIGNS LIST

1, 1a, 1b, 1c: Excavation point identification apparatus
2: Measurement apparatus
3: Excavation apparatus
4: Communication network
5: Control apparatus
6: Computer
7: Storage medium
11: Acquisition section
12: Extraction section
13: Inference section
14: Selection section
15: Area division section
16: Communication section
61: Processor
62: Memory
63: Internal bus

What is claimed is:

1. An excavation point identification apparatus comprising at least one processor, the at least one processor carrying out:
an acquisition process of acquiring pieces of height information at a plurality of points in an excavation target which is to be excavated by an excavation apparatus;
an extraction process of extracting a plurality of excavation point candidates with reference to the pieces of height information, each of the plurality of excavation point candidates being a candidate for an excavation point at which the excavation apparatus starts excavation;
an inference process of inferring, based on an excavation track of the excavation apparatus, an excavation amount for each of the plurality of excavation point candidates which have been extracted, the excavation amount being an amount by which the excavation apparatus carries out excavation; and
a selection process of selecting an excavation point from among the plurality of excavation point candidates based on the excavation amount which has been inferred.

2. The excavation point identification apparatus according to claim 1, wherein:
the at least one processor further carries out an area division process of dividing an area including the excavation target into a plurality of meshes; and
in the extraction process, the at least one processor extracts, as the excavation point candidate, a mesh from among the plurality of meshes in accordance with height information of the excavation target.

3. The excavation point identification apparatus according to claim 2, wherein:
in the area division process, the at least one processor calculates a size of each of the plurality of meshes such that the number of measurement points of a measurement apparatus included in the mesh is not less than a predetermined number.

4. The excavation point identification apparatus according to claim 2, wherein:
in the inference process, the at least one processor infers the excavation amount with reference to pieces of height information in meshes included in the excavation track of the excavation apparatus.

5. The excavation point identification apparatus according to claim 1 wherein:
in a case where an excavation region that is indicated by an excavation track, where a first excavation point candidate included in the plurality of excavation point candidates is assumed to be an excavation point, includes a second excavation point candidate included in the plurality of excavation point candidates in the extraction process, the at least one processor excludes the second excavation point candidate from the plurality of excavation point candidates.

6. The excavation point identification apparatus according to claim 1 wherein:
in the extraction process, the at least one processor does not set the excavation point candidate in a range which is unreachable by a shovel of the excavation apparatus.

7. An excavation point identification system comprising at least one processor, the at least one processor carrying out:
a measurement process of measuring an area including an excavation target which is to be excavated by an excavation apparatus;
an acquisition process of acquiring, with reference to measurement information which has been received, pieces of height information at a plurality of points in the excavation target which is to be excavated by the excavation apparatus;
an extraction process of extracting a plurality of excavation point candidates with reference to the pieces of height information, each of the plurality of excavation point candidates being a candidate for an excavation point at which the excavation apparatus starts excavation;
an inference process of inferring, based on an excavation track of the excavation apparatus, an excavation amount for each of the plurality of excavation point candidates which have been extracted, the excavation amount being an amount by which the excavation apparatus carries out excavation; and
a selection process of selecting an excavation point from among the plurality of excavation point candidates based on the excavation amount which has been inferred.

8. The excavation point identification system according to claim 7, wherein:
the at least one processor further carries out an area division moans process of dividing an area including the excavation target into a plurality of meshes; and
in the extraction process, the at least one processor extracts, as the excavation point candidate, a mesh from among the plurality of meshes in accordance with height information of the excavation target.

9. The excavation point identification system according to claim 8, wherein:
in the area division process, the at least one processor calculates a size of each of the plurality of meshes such that the number of measurement points included in the mesh in the measurement process is not less than a predetermined number.

10. The excavation point identification system according to claim 8, wherein:
in the inference process, the at least one processor infers the excavation amount with reference to pieces of height information in meshes included in the excavation track of the excavation apparatus.

11. The excavation point identification system according to claim 7, wherein:
in a case where an excavation region that is indicated by an excavation track, where a first excavation point candidate included in the plurality of excavation point candidates is assumed to be an excavation point, includes a second excavation point candidate included in the plurality of excavation point candidates in the extraction process, the at least one processor excludes the second excavation point candidate from the plurality of excavation point candidates.

12. The excavation point identification system according to claim 7, wherein:
in the extraction process, the at least one processor does not set the excavation point candidate in a range which is unreachable by a shovel of the excavation apparatus.

13. An excavation point identification method, comprising:
acquiring pieces of height information at a plurality of points in an excavation target which is to be excavated by an excavation apparatus;
extracting a plurality of excavation point candidates with reference to the pieces of height information, each of the plurality of excavation point candidates being a candidate for an excavation point at which the excavation apparatus starts excavation;
inferring, based on an excavation track of the excavation apparatus, an excavation amount for each of the plurality of excavation point candidates which have been extracted, the excavation amount being an amount by which the excavation apparatus carries out excavation; and
selecting an excavation point from among the plurality of excavation point candidates based on the excavation amount which has been inferred.

14. The excavation point identification method according to claim 13, further comprising:
dividing an area including the excavation target into a plurality of meshes, in the extracting of the plurality of excavation point candidates, a mesh from among the plurality of meshes is extracted as the excavation point candidate in accordance with height information of the excavation target.

15. The excavation point identification method according to claim 14, wherein:
in the dividing into the plurality of meshes, a size of each of the plurality of meshes is calculated such that the number of measurement points of a measurement apparatus included in the mesh is not less than a predetermined number.

16. The excavation point identification method according to claim 14, wherein:
in the inferring of an excavation amount by which the excavation apparatus carries out excavation, the excavation amount is inferred with reference to pieces of height information in meshes included in the excavation track of the excavation apparatus.

17. The excavation point identification method according to claim 13, wherein:
in a case where an excavation region that is indicated by an excavation track, where a first excavation point candidate included in the plurality of excavation point candidates is assumed to be an excavation point, includes a second excavation point candidate included in the plurality of excavation point candidates, the second excavation point candidate is excluded from the plurality of excavation point candidates in the extracting of the plurality of excavation point candidates.

18. The excavation point identification method according to claim 13, wherein:
in the extracting of the plurality of excavation point candidates, the excavation point candidate is not set in a range which is unreachable by a shovel of the excavation apparatus.
